(19) United States
(12) Patent Application Publication
(10) Pub. No.: US 2009/0216436 A1
(43) Pub. Date: Aug. 27, 2009

(54) NAVIGATION DEVICE CAPABLE OF DISPLAYING LOCAL LABELS AND METHOD THEREOF

(75) Inventor: Neng Liu, Hsinchu City (TW)

Correspondence Address: EGBERT LAW OFFICES, 412 MAIN STREET, 7TH FLOOR, HOUSTON, TX, 77002, US

(73) Assignee: MITAC INTERNATIONAL Corp., Kuei San Hsiang (TW)

(21) Appl. No.: 12/368,909

(22) Filed: Feb. 10, 2009

(30) Foreign Application Priority Data
Feb. 21, 2008 (TW) 097106153

(51) Int. Cl. G01C 21/36

(52) U.S. Cl. 701/209

(57) ABSTRACT

The present invention discloses a navigation device which is capable of displaying local labels and a method thereof. The navigation device comprises a map database, a navigation module, a positioning module and a display interface. The map database is capable of storing at least one electronic map, comprising a plurality of map blocks. The navigation module is capable of providing a navigation route located on at least one of the plurality of map blocks, and the navigation route comprises a starting point, a plurality of local labels and a destination. The local labels are located from the starting point to the destination in order. The positioning module is capable of providing at least one positioning location. The display interface is capable of displaying at least one of the plurality of map blocks where the navigation route is located on according to the positioning location, and displays at a next local label on the map blocks. The next local label is located on one end of the navigation route toward a direction of the destination.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention is related to the technical field of a navigation device, particularly to a navigation device which is capable of displaying a local label and a method thereof.

2. Description of Related Art Including Information Disclosed Under 37 CFR 1.97 and 37 CFR 1.98

At present, on many roads, such as express highways, provincial roads, intersections or mountain paths, users can see all kinds of local labels and the directional indications thereof everywhere, such as “↑ Taipei City”, “→ Taoyuan”, “← Puli”, “Alishan [symbol] , “Kenting [symbol] , and so on. These indications let the users know the correct direction of the next region they are approaching or the correct direction of the destination they are going to, so as to prevent the users from wasting much valuable time. They will go astray if they are not familiar with the roads or they don't pay attention to roads for a while.

Additionally, on a paper map, the users can also see the local labels and the directional indications which are similar to the above-mentioned, such as “→ Taichung City”, “Taiping [symbol] ”, and so on. Because a paper map usually shows the partial map of the information only, it cannot be unfolded into a complete map or an overall picture. With the local labels, the users can understand the next region. The directional indication let the users clearly know the direction they are going to, particularly when they are on complicated mountain roads, forked roads, or strange places. The importance of the local label to users is matter-of-course.

Though the local labels and the directional indications thereof give much aid to users, the local labels and the directional indications are only set up on roads or illustrated in the paper maps at present. A current phase of markets or products don't provide related techniques to set up the local labels in the electronic maps of the navigation device, so as to benefit the users to know the correct direction toward the destination at any time when they are driving or in the course of going to the destination. For this point, how to set up the local labels and the directional indications thereof in the electronic maps of the navigation device becomes a topic which is a concern of many users.

In order to solve the drawbacks of the foregoing techniques so as to satisfy the users' demand for a navigation device, based on engaging in research for many years and many practical experiences, the inventor discloses by research and special subject explorations in many ways that the present invention comprises a navigation device capable of displaying local labels and a method thereof.

### BRIEF SUMMARY OF THE INVENTION

In view of the topic, the object of the present invention is to provide a navigation device capable of displaying local labels and a method thereof, particularly to localize the local labels and the directional indications thereof in the electronic map of the navigation device, so as to satisfy the users' demand for the navigation device, and improve the drawbacks of foregoing technique in the meantime. The navigation device lets the users not only know the next region they are going to, but also clearly identifies the correct direction toward the destination. Furthermore, the navigation device further comprises speech-reminding messages to prevent the users from driving to a wrong road.

Therefore, to achieve the object, the present invention discloses a navigation device capable of displaying local labels. The navigation device comprises a map database, a navigation module, a positioning module and a display interface. Among them, the map database is capable of storing at least one electronic map comprising a plurality of map blocks. The navigation module is coupled to the map database and capable of providing a navigation route located on at least one of the plurality of map blocks. The navigation route comprises a starting point, a plurality of local labels and a destination. The local labels are localized from the starting point to the destination in order. The positioning module is capable of providing at least one positioning location. Besides, the display interface is coupled to the map database, the navigation module and the positioning module so as to display one of the map blocks where the navigation route is located on according to the positioning location, and the display interface is capable of displaying at least one of the plurality of map blocks where the navigation route is located on according to the positioning location. The next local label is located on one end of the navigation route toward a direction of the destination.

Moreover, the present invention discloses a method of displaying local labels, which comprises the steps of:
(a) Providing a navigation device, which comprises a map database, a navigation module, a positioning module and a display interface, wherein the map database is capable of storing at least one electronic map comprising a plurality of map blocks.
(b) Using the navigation module to provide a navigation route located on at least one of the plurality of map blocks. The navigation route comprises a starting point, a plurality of local labels and a destination, and the local labels are located from the starting point to the destination in order.
(c) Using the positioning module to provide at least one positioning location.
(d) Enabling the display interface to display at least one of the plurality of map blocks where the navigation route is located on according to the positioning location.
(e) Enabling the display interface to display a next local label on the map blocks, and wherein the next local label is located on one end of the navigation route toward a direction of the destination.

In order to make examiners further understand the technical characteristics and achieved effect of the present invention, the following contents are provided with preferred embodiments and the related drawings for assistance, and matched with a detailed description as follows.

### BRIEF DESCRIPTION OF THE SEVERAL VIEWS OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram of according to the present invention comprising the navigation device capable of displaying local labels.

FIG. 2 is a schematic diagram of a preferred embodiment of the present invention comprising a navigation device capable of displaying local labels.

FIG. 3 is a flow chart of the method of displaying local labels according to the present invention.

### DETAILED DESCRIPTION OF THE INVENTION

For the better understanding of the object, characteristics and advantages of the present invention and according to the present invention, a navigation device is capable of displaying local labels and a method thereof. The following content is provided with preferred embodiments corresponding to the related drawings as a detailed description. The identical elements are illustrated with the identical element symbols.

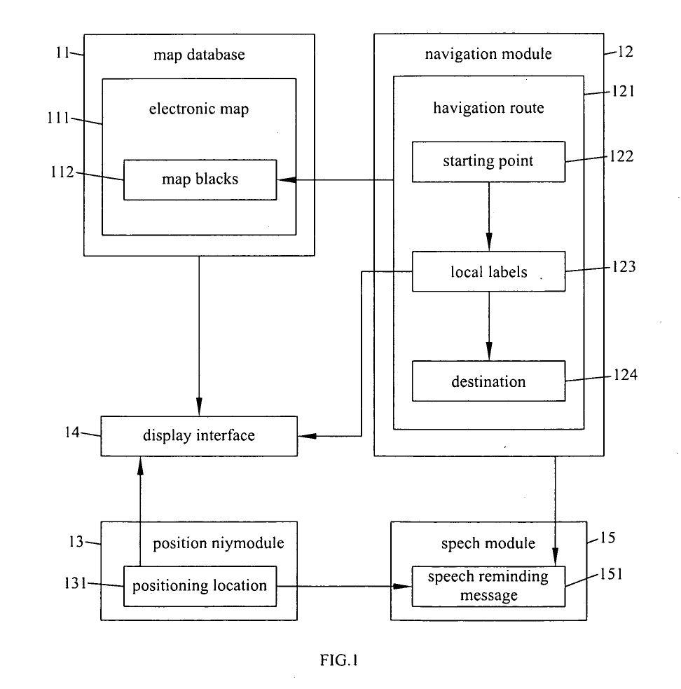

Referring to FIG. 1 for a schematic diagram of the present invention comprising a navigation device capable of displaying local labels, the navigation device comprises a map database 11, a navigation module 12, a positioning module 13 and a display interface 14. An input module (not shown in the drawing) and a speech module 15 can also be added. Among them, the map database 11 is capable of storing at least one electronic map 111, which comprises a plurality of map blocks 112.

Furthermore, the navigation module 12 is coupled to the map database 11 and is capable of providing a navigation route 121 located on at least one of the map blocks 112. The navigation route 121 comprises a starting point 122, a plurality of local labels 123 and a destination 124. The local labels 123 are preferred to be a County/City label, a Village/Town label, or a scenic spot label, such as “to Taipei”, “to Taoyuan”, “to Puli”, “to Alishan”, “to Kenting”, and so on. Moreover, the local labels 123 are located in order from the starting point 122 to the destination 124 according to a preset arrangement manner. The display interface 14 displays at least one of the plurality of map blocks where the navigation route 121 is located on according to the positioning location 131, and displays a next local label 123 located on one end of the navigation route toward a direction of the destination. Each of the local label 123 comprises a directional indication, such as “↑”, “→”, “←”, [symbol] , [symbol] , and so on, for guiding a user or a vehicle toward a direction of the destination 124.

A positioning module 13 is capable of providing at least one positioning location 131 for the users or vehicles. Moreover, the display interface 14 is coupled to the map database 11, the navigation module 12, and the positioning location 131, and is capable of displaying at least one of the plurality of map blocks 112 where the navigation route 121 is located on according to the positioning location 131, and displays a next local label 123 located on the map blocks 112. The next local label 123 is located on one end of the navigation route 121 on the display interface 14 toward a direction of the destination 124. By this manner, the navigation device provides sufficient navigation route information and the correct direction for going to the destination 124, so as to prevent the users from going astray.

The input module is capable of inputting at least one of the starting point 122, the midway point and the destination 124. The speech module 15 is capable of generating a speech reminding message 151 according to the navigation route 121 and positioning location 131. For instance, “Continue going straight, and then you can reach Taichung City”, “If you are going to Taipei City, please turn left in 500 m in the front”, and so on, so as to remind the users to pay attention to the driving direction toward the next region.

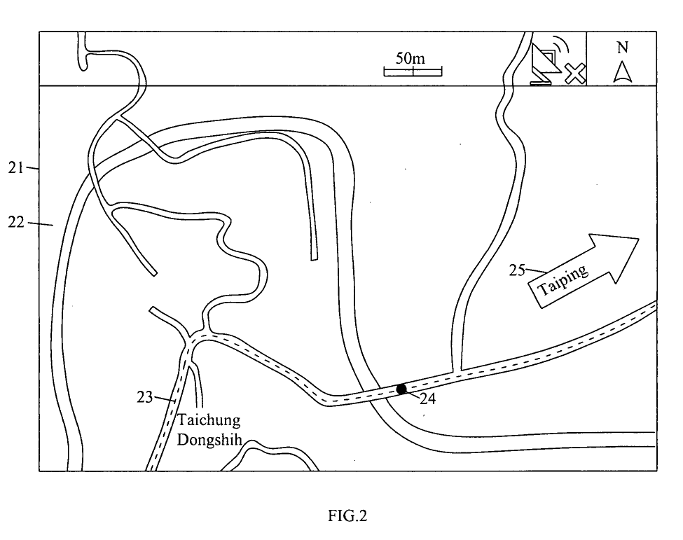

Referring to FIG. 2 for a schematic diagram of a preferred embodiment of the present invention comprising a navigation device capable of displaying local labels, before starting to navigate, first at least one electronic map is stored in a map database (not shown in the drawing) of the navigation device. The electronic map comprises a plurality of map blocks 22. Next, a navigation module (not shown in the drawing) of the navigation device is used to provide a navigation route 23 located on at least one of the plurality of map blocks 22. The navigation route 23 comprises a starting point, a plurality of local labels 25 and a destination.

For example, if the starting point and the destination are “Taichung City” and “Taiping”, respectively, the navigation module is capable of automatically planning the local labels 25 and a navigation route 23 from “Taichung City” passing “Dongshih” to “Taiping”. While navigating, the user starts from “Taichung City”, namely, the positioning location 24 is located on “Taichung City”, then the display interface 21 displays the map blocks 22 and the navigation route 23 of “Taichung City” and the display interface displays the local labels 25 of “to Dongshih ↑” and the directional indication thereof located on one end of the navigation route 23 toward a direction of “Taiping” for guiding the users to go to “Taiping”. After the user arriving in “Dongshih”, namely, the positioning location 24 is located on “Dongshih”, then the display interface 21 changes the display and displays the map blocks 22 and the navigation route 23 of “Dongshih”. The display displays the local labels 25 of “to Taiping←” and the directional indication thereof located on one end of the navigation route 23 toward a direction of “Taiping” until the users arrives in “Taiping”.

While navigating, a speech module of the navigation device is also capable of generating a speech reminding message according to the positioning location 24, such as “Continue going straight, and then you will reach Dongshih”, or “If you are going to Taiping, please turn right in the front”, and so on. The speech reminding message is capable of reminding the users to pay attention to the driving direction toward the next region.

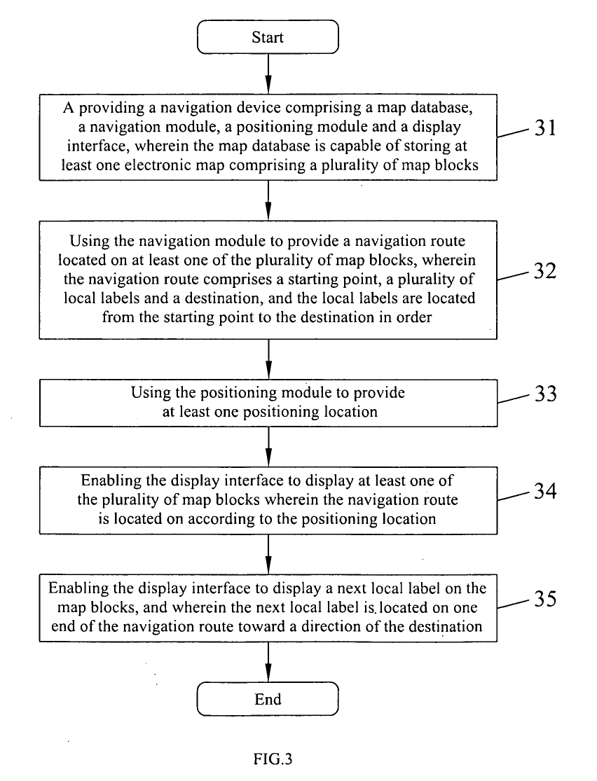

Referring to FIG. 3, this is a flow chart of the method of displaying local label of the present invention. This method corresponds to the schematic diagram of the navigation device which is capable of displaying the local label, and comprises the steps of:

Step 31: Providing a navigation device mainly comprising a map database 11, a navigation module 12, a positioning module 13 and a display interface 14. An input module (not shown in the drawing) and a speech module can also be added. The map database 11 is capable of storing at least one electronic map 111 comprising a plurality of map blocks 112.

Step 32: Using the navigation module 12 to provide a navigation route 121 located on at least one of the plurality of map blocks 112. The navigation route 121 comprises a starting point 122, a plurality of local labels 123 and a destination 124. The local labels 123 comprise a County/City label, a Village/Town label, or a scenic spot label, such as “to Taipei City”, “to Taoyuan”, “to Puli”, “to Alishan”, “to Kenting”, and so on. Moreover, the local labels 123 are located in order from the starting point 122 to the destination 124 according to the preset arrangement manner, and the display interface 14 displays a next local label 123 according to the positioning location 131. Each of the local labels 123 comprises a directional indication, such as “↑”, “→”, “←”, [symbol] , [symbol] and so on, for guiding a user or a vehicle toward a direction of destination 124.

Step 33: Using the positioning module 13 to provide at least one positioning location 131 to display the current location of a user or a vehicle.

Step 34: Enabling the display interface to display at least one of the plurality of map blocks 112 where the navigation route 121 is located on according the positioning location.

Step 35: Enabling the display 14 interface to display a next local label 123 located on the map block 112 according to the positioning location 131, and wherein the next local label 123 is located on one end of the navigation route 121 on the display interface 14 toward one direction of the destination 124. By the manner, sufficient navigation route information and correct direction toward a direction of the destination 124 is provided for preventing the user from going astray.

For special descriptions, the input module is capable of inputting the starting point 122, the midway point or the destination 124. The speech module 15 is capable of generating a speech reminding message 151 according to the navigation route 121 and the positioning location 131, such as “Continue going straight, and then you will reach Taichung City”, “If you are going to Taipei City, please turn left in 500 m in the front”, and so on, so as to remind the user to pay attention to the driving direction toward the next region

1. A navigation device capable of displaying local labels, comprising:
a map database means for storing at least one electronic map comprising a plurality of map blocks;
a navigation means, being coupled to the map database and providing a navigation route located on at least one of the plurality of map blocks, the navigation route comprising a starting point, a plurality of local labels and a destination, and wherein the local labels are located from the starting point to the destination in order;
a positioning means for providing at least one positioning location; and
a display interface means, being coupled to the map database, the navigation module and the positioning module, displaying at least one of the plurality of map blocks wherein the navigation route is located on according to the positioning location, and displaying a next local label located on one end of the navigation route toward a direction of the destination.

2. The navigation device capable of displaying local labels of claim 1, wherein the local labels comprise a County/City label, a Village/Town label, or a scenic spot label.

3. The navigation device capable of displaying local labels of claim 1, wherein the local labels are located according to a preset arrangement manner.

4. The navigation device capable of displaying local labels of claim 1, wherein each of the local labels comprises a directional indication for guiding a user or a vehicle to proceed to the destination.

5. The navigation device capable of displaying local labels of claim 1, further comprising.
an input means for inputting at least one of the starting point, a midway point and the destination.

6. The navigation device capable of displaying local labels of claim 1, further comprising:
a speech means for generating a speech reminding message according to the navigation route and the positioning location.

7. A method of displaying local labels for navigation, comprising the steps of:
(a) providing a navigation device comprising a map database, a navigation module, a positioning module and a display interface, wherein the map database is capable of storing at least one electronic map comprising a plurality of map blocks;
(b) using the navigation module to provide a navigation route located on at least one of the plurality of map blocks, wherein the navigation route comprises a starting point, a plurality of local labels and a destination, and the local labels are located from the starting point to the destination in order.
(c) using the positioning module to provide at least one positioning location;
(d) enabling the display interface to display the at least one of the plurality of map blocks wherein the navigation route is located on according to the positioning location; and
(e) enabling the display interface to display a next local label on the map blocks, and wherein the next local label is located on one end of the navigation route toward a direction of the destination.

8. The method of displaying local labels for navigation of claim 7, wherein the local labels comprise a County/City label, a Village/Town label, or a scenic spot label.

9. The method of displaying local labels for navigation of claim 7, wherein the local labels are located according to a preset arrangement manner.

10. The method of displaying local labels for navigation of claim 7, wherein each of the local labels comprises a directional indication for guiding a user or a vehicle to proceed to the destination.

11. The method of displaying local labels for navigation of claim 7, wherein the navigation device further comprises an input module capable of inputting at least one of the starting point, a midway point and the destination.

12. The method of displaying local labels for navigation of claim 7, wherein the navigation device further comprises a speech module capable of generating a speech reminding message according to the navigation route and the positioning location.
